(19) United States
(12) Patent Application Publication
(10) Pub. No.: US 2003/0013064 A1
(43) Pub. Date: Jan. 16, 2003

(54) Rinsing cannula for rinsing a root canal of a tooth

(76) Inventor: Christoph Zirkel, Koln (DE)

Correspondence Address: VOLPE AND KOENIG, P.C., SUITE 400, ONE PENN CENTER, 1617 JOHN F. KENNEDY BOULEVARD, PHILADELPHIA, PA, 19103, US

(21) Appl. No.: 10/182,342

(22) PCT Filed: Jan. 25, 2001
(86) PCT No.: PCT/EP01/00833

(30) Foreign Application Priority Data
Jan. 29, 2000 (DE) 200 01 584.2

(51) Int. Cl. A61C 5/02

(52) U.S. Cl. 433/81; 433/224

(57) ABSTRACT

A rinsing cannula (1) to rinse a root canal (2) of a tooth (3) having a supply channel for rinsing fluid. A proximal end area of the rinsing cannula (1) is connected to or connectable to a syringe or similar fluid supply and has at least one inlet opening (6), and a distal end area of the rinsing cannula (1) that is insertable into the root canal (2) in its position of use has at least one outlet opening (7) for the rinsing fluid. The distal end area of the rinsing cannula (1) is formed of titanium or a titanium alloy for flexible adaptation of the end area to the shape of the root canal (2) when it is inserted.

This invention pertains to a rinsing cannula to rinse a root canal of a tooth, wherein the rinsing cannula has a supply channel for a rinsing fluid that has at least one inlet opening at the proximal end area of the rinsing cannula that connects to or is able to connect to a syringe or similar fluid supply, and has at least one outlet opening for the rinsing fluid at the distal end area of the rinsing cannula that is inserted into the root canal in the position of use.

Rinsing of a root canal with antibacterial agent and tissue-dissolving fluid, or chemical debridement, is an important element of root canal preparation in dental medicine. In numerous studies, it has been verified that it is not possible to sufficiently prepare all endodontic regions using mechanical means alone. There always remain wall regions of differing dimensions that instruments cannot reach. After treatment using a mechanical instrument, the wall of the root canal is still covered with debris and a film that consists of ground dentin, but can also contain bacteria. Since this film compromises the seal of the root canal filling that is injected into the root canal during root canal treatment and can be a source of re-infection of the endodontium, it should be removed as much as possible through rinsing with adequate agents. The root canal rinse removes dentin shavings that still remain in the root canal and can block the root canal. Also, the root canal rinse enables any organic and inorganic root canal contents to be dissolved, even in areas of the complex endodontic system that are not accessible to instrument treatment. This removes a majority of the substrate necessary for the survival of any remaining bacteria. Other purposes of the root canal rinse are to disinfect the endodontium, introduce a lubricant for root canal instruments to be inserted into the root canal, as well as to provide a bleaching effect on the coronal and radicular hard tooth substances.

From EP-A-0 290 111, a rinsing cannula in accordance with the above-noted state of the art is known, that has a cannula end part made of stainless steel, that is with its one end connected to a rinsing fluid supply containing syringe. On its other end which is inserted into the root canal in the working position, the cannula part includes two openings that are spaced from one another in the extension direction for rinsing fluid, that are connected to the rinsing fluid supply through an axially extending feed channel. Through these outlet openings, the rinsing fluid is directed into the root canal.

The rinsing cannula has, however, the disadvantage in that it can only be partially inserted into the root canal due to the fact that in practice the root canal is always bent. Because of this, the rinsing of the root canal near the tip of the root is difficult. Near the tip of the root, organic or inorganic residue can thus remain in the root canal, which can lead to re-infection of the endodontium.

From U.S. Pat. No. 4,276,880, a suction/rinsing cannula for a combined suction/rinsing apparatus is known in which the cannula part has a known flexibility. The suction/rinsing cannula has diametrically opposed openings arranged in its end area, that on the one hand reduce the hydraulic pressure on the tissue surrounding the tooth and through which in the other hand should provide a suction area. Again this cannula makes possible only a limited cleaning of the root canal in the area of the root tip.

Thus, the object arises of creating a rinsing cannula of the type mentioned above that makes it possible to perform a complete and thorough rinsing of the root canal by the rinsing fluid along the entire length of the root canal even in bent root canals, and in a simple manner.

The solution to this object is that the distal end area of the rinsing cannula is formed of titanium or a titanium alloy for flexible adaptation of the end area according to the shape of the root canal as it is inserted, and that the outlet openings on the distal end area of the rinsing cannula are located diametrically opposed to one another.

The distal end area of the rinsing cannula is thus flexibly designed so that it adjusts its shape according to the curvature of the root canal as it is inserted. In an advantageous manner, this allows the rinsing cannula to be inserted into the root canal up to the tip of the root so that it can be thoroughly rinsed along its entire length with the rinsing fluid. Through the diametrically opposed openings a good mechanical stability is achieved for the cannula part in the area of the outlet openings and also the rinsing fluid is dispersed on both sides of the root canalat the same time. In this way, the rinsing cannula enables a complete cleaning and disinfection of the root canal. In particular, the danger of re-infection of the root canal by organic and inorganic residue remaining in the root canal is mostly prevented.

It is especially advantageous if the titanium alloy is a shape-memory alloy and in particular contains nickel and/or aluminum as the alloying component (e). The rinsing cannula adapts itself according to the respective curvature of the root canal in its position of use, but re-assumes its original, preferably straight shape after it is removed from the root canal due to its shape memory effect. The rinsing cannula can, if necessary, be subjected to a temperature treatment after removal from the root canal, so as to help it return to its original shape due to the memory effect. Thus, when the rinsing cannula is re-introduced to the root canal, a stressing of the material in the rinsing cannula as a result of its having been previously bent is prevented so that the danger of breakage of the rinsing cannula when inserted or removed from the root canal, as well as during the rinse procedure is for the most part prevented. The rinsing cannula is especially suited for multiple use.

In an advantageous embodiment of the invention, a number of outlet openings are located along the outside of the distal end area of the rinsing cannula that are spaced from one another along its perimeter. In particular, these outlet openings are formed by making perforations in the side of the outer wall of the supply channel located there. This results in the rinsing cannula providing an even better and more even cleaning of the entire root canal.

At the proximal end area of the rinsing cannula, a coupling receptacle can be provided, preferably having a screw thread for removable connection to a matching coupling of a syringe or similar fluid supply that fits it. The coupling created by the coupling receptacle and its matching coupling enables a good connection of the rinsing cannula to the syringe when in use. However, the coupling is still easy to remove if the rinsing cannula has to be sterilized in an autoclave, for example.

An preferred embodiment of the invention is explained in more detail below in view of the drawings. Shown are:

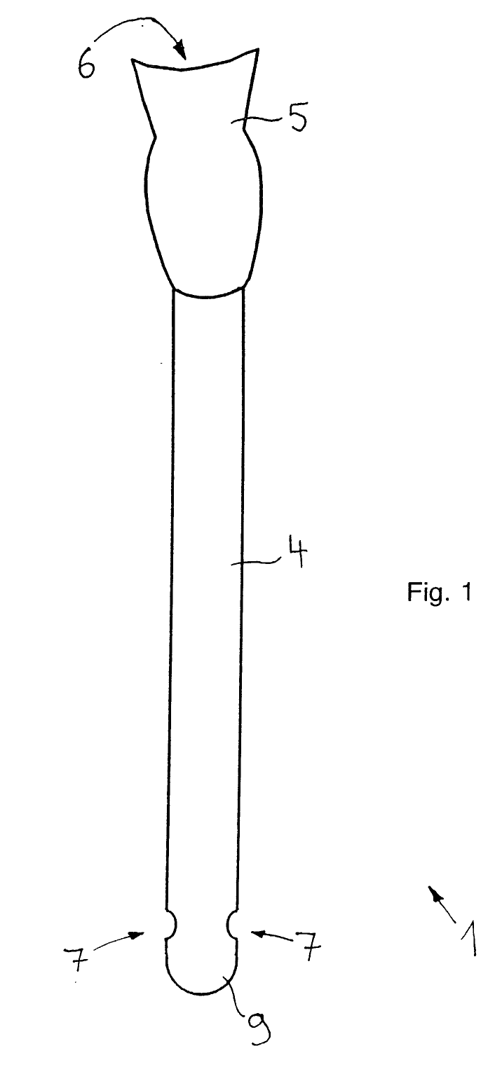

FIG. 1 is a schematically represented side view of a rinsing cannula and

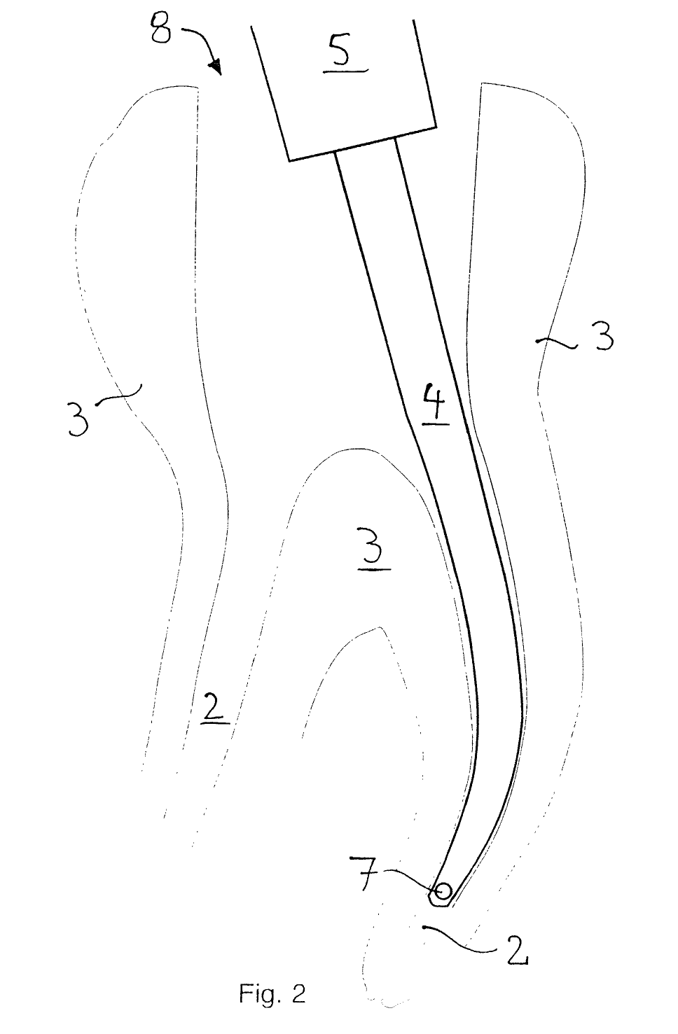

FIG. 2 is a longitudinal section through a tooth in whose root canal the rinsing cannula is introduced.

A rinsing cannula identified in its entirety as 1, used to rinse a root canal 2 of a tooth 3, has a cannula section 4 with a supply channel located therein for a rinsing fluid. At one of the axial ends of the cannula section 4 is a coupling receptacle 5 that is removably connectable to a matching coupling section of a syringe having a rinsing fluid supply. The supply channel has an inlet opening 6 at the coupling receptacle 5 and outlet openings 7 for the rinsing fluid at the distal end area of the cannula section 4 opposite the coupling receptacle 5.

The cannula section 4 is formed of a bendable titanium alloy that can contain, for example, between 40 and 60 weight percent titanium and at least one other alloy component, namely a soft metal such as nickel or aluminum. The material of the cannula section 4 has a memory effect i.e. it deforms under a bending stress and re-assumes its original shape essentially when the bending stress is removed.

To rinse the root canal 2, the distal end area of the rinsing cannula 1 having the outlet openings 7 is inserted into the root canal 2 through an opening 8 made previously in the tooth 3. In the process, the cannula section 4 is flexibly deformed by the force exerted on the rinsing cannula 1 when it is inserted, adjusting its shape to the curved shape of the root canal 2. In FIG. 2, it can be clearly seen that the free end of the cannula section 4 inserted into the root canal 2 is bent according to the shape of the root canal 2. In FIG. 2, it can be clearly seen that the free end of the cannula section 4 inserted into the root canal 2 is bent according to the shape of the root canal 2, unlike the remaining areas of the cannula section 4. The cannula section 4 can thus be introduced into the root canal 2 up to the tip of the root. Then, the rinsing fluid is introduced through the outlet openings 7 into the root canal 2 by activating the syringe. In this manner, practically all of the organic and inorganic root canal contents located in the root canal 2 are rinsed out of the root canal 2 and the root canal 2 is disinfected.

In FIG. 1 it can be seen that the distal end area of the rinsing cannula 1 is closed at the end by a cap section 9 and that the outlet openings 7 are located to the side at the distal end area of the rinsing cannula 1. In this case, there are two outlet openings 7 diametrically opposing one another on the perimeter of the cannula section 4. Of course, there are also other embodiments conceivable in which, for example, three or more outlet openings 7 can be distributed on the perimeter of the cannula section 4. The outlet openings 7 can, for example, be produced by making slots and/or holes in the wall of the cannula section 4.

To rinse a root canal 2 of a tooth, the rinsing cannula 1 has a supply channel for rinsing fluid. At the proximal end area of the rinsing cannula 1 connected or connectable to a syringe or similar fluid supply, there is at least one inlet opening 6 and at the distal end area of the rinsing cannula 1 inserted into the root canal 2 in its position of use there is at least one outlet opening 7 for the rinsing fluid. The distal end area of the rinsing cannula 1 is formed of titanium or a titanium alloy to flexibly adjust the end area to the shape of the root canal 2 when it is inserted.

What is claimed is:

1. A rinsing cannula (1) to rinse a root canal (2) of a tooth (3), comprising a supply channel for a rinsing fluid that has at least one inlet opening (6) at a proximal end area of the rinsing cannula that connects to or is adapted to connect to a syringe or fluid supply, and has at least one outlet opening (7) for the rinsing fluid at a distal end area of the rinsing cannula (1) that is inserted into the root canal (2) in a position of use, a closed end area of the rinsing cannula (1) including side outlet openings, wherein the distal end area of the rinsing cannula (1) is formed of titanium or a titanium alloy to flexibly adapt the distal end area to a shape of the root canal (2) during insertion, and the exit openings on the distal end area of the rinsing cannula are arranged diametrically opposed to one another.

2. A rinsing cannula (1) according to claim 1, wherein the titanium alloy is a shape-memory alloy and contains nickel and/or aluminum as a alloying component (e).

3. A rinsing cannula (1) according to claim 1 or 2, wherein the outlet openings (7) are formed by perforations located in the outer side wall of the supply channel.

4. A rinsing cannula (1) according to one of claims 1 through 3, wherein at the proximal end area of the rinsing cannula (1), a coupling receptacle (5) is provided, preferably having a screw thread for removable connection to a matching coupling section of a syringe or fluid supply.
